(19) United States
(12) Patent Application Publication
(10) Pub. No.: US 2005/0068190 A1
(43) Pub. Date: Mar. 31, 2005

(54) Personal retail tool and server system

(76) Inventor: Robert Krause, Berkeley, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/949,462

(22) Filed: Sep. 24, 2004

Related U.S. Application Data
(60) Provisional application No. 60/507,804, filed on Sep. 30, 2003.

(51) Int. Cl. G05B 19/02

(52) U.S. Cl. 340/825.22

(57) ABSTRACT

A small personal retail tool wirelessly connects to a wireless retail transaction server. The server sends information concerning the store's menu to the retail tool. The customer is then able to select from the menu and order using the personal retail tool. The retail server processes the order and requests payment from the retail tool. The retail tool then optionally requests a PIN number from the customer in order to access stored payment information. The order is completed and the connection is terminated. The retail server is designed to appear as a cash register to a retailer's back-end server. However, instead of going through a cashier, the retail server enables customers to place orders and make payment on their own, without first waiting in line, without rushing and without interacting with a cashier. Customers who would rather place their order with a cashier can still use the retail server solely to pay for their purchases.

### REFERENCE TO RELATED APPLICATION

This application claims priority under 35 U.S.C. § 119(e) to U.S. provisional application No. 60/507,804, filed Sep. 30, 2003, the disclosure of which is incorporated herein by reference.

### FIELD OF THE INVENTION

The present invention relates to systems, devices and methods for facilitating retail transactions.

### BACKGROUND OF THE INVENTION

Recent advances in technology have facilitated many types of retail transactions. For example, the internet has practically replaced catalog shopping due to its improved interactivity, the ability to browse multiple shopping sites from a single location, lack of limitation on hours of operation, and an ability to tailor received information either through consumer specifications or profiling conducted by the merchant. From the merchants' perspective, the Internet has allowed better inventory management through automation and has thus reduced costs. There are, however, limitations on the ability of the Internet to replace all retail sales. Many sales are simply not suited to Internet communication, and physical store locations will continue to thrive where services need to be performed that cannot be provided over a network, where the goods are to be consumed at the point-of-sale (POS), or where the user needs to see or test the goods before taking them home (e.g., trying on clothing for size).

Despite all of the advances in wireless technology in computers, technology has not much changed the user's experience at retail shopping outlets. While computers, networking and automation more generally may have improved back-end inventory management, the retailer's interaction with the consumer remains essentially unchanged by recent advances in technology.

One aspect of the retailer-consumer interaction relates to the method of payment. Cash, checks and credit/debit cards remain the predominant manner in which payment transactions are conducted. One attempt to facilitate payment and at the same time foster brand loyalty has been to establish store-specific accounts into which the consumer makes periodic deposits. Often the value is represented or stored on a physical instrument such as a plastic card with a magnetic strip (e.g., coffee house chain cards or phone cards) or bulkier packages (e.g., wireless devices for deducting bridge or highway tolls from a pre-paid account). Still other methods allow wireless communication with a simple identifying device that has been previously connected to a debit or credit account. For example, at least one gasoline retailer employs radio frequency identification (RFID) technology on a simple keychain device that allows the consumer to pass his or her keychain in front of a pad, after which the retailer's networking equipment connects the sale and purchase amount to the consumers' credit account and automatically charges that amount to that account. These latter devices tend to be very specific to a particular retailer or retail chain.

On another front, smart cards are becoming more prevalent in which a chip on a credit card itself stores information about the consumer, is more reliable and safe than magnetic strips, and is additionally programmable to store different types of information on the card itself. The cards themselves, however, are not interactive. Still another trend, particularly in Asia and Europe, is to allow ordering and/or payment to be conducted by use of a wireless phone or personal data assistant (PDA). For example, one common method is to employ a cell phone to wirelessly communicate at short range with vending machines, and apply the charges for the ordered items to the phone bill associated with the cell phone. However, such systems are rather limited in their flexibility and involve numerous contractual arrangements with various cell phone manufacturers, vending machine manufacturers and wireless telephone service companies. Moreover, cell phones are rather bulky compared to, for example, credit or bank cards, such that such systems have remained limited to particular vending machines in confined geographic areas and have not found widespread use among retail applications. Furthermore, such transactions (whether employing a wireless telephone or a PDA through the Internet) tend to involve additional time and expense in connecting to a wide area network, and consume considerable power in the process.

Another aspect of the retail transaction is the register end of the transaction. Traditional cash registers are slow, and require the use of an employee. Customers must wait in line for the employee to complete the orders of other customers. While this offers the most personal touch, many customers prefer a quicker system of ordering. Lines during peak periods can cause a loss of sales as customers might abandon a small purchase in order to save time. As discussed before, PDAs and smartphones can be used to contact a server at the retail establishment using wireless communications. However, these servers are costly to purchase and maintain.

Self-ordering consoles, devices developed in order to solve this problem, are becoming popular in some businesses. However, they are expensive, take up large amounts of floor space, and are limited to only one user at a time. Payment using these systems can be quite a problem, too. The retail operation can either have an employee tending the self-ordering console, or the console can have a vending-machine type money deposit. If an employee tends the console, most or all of the cost savings garnered by the use of the console are lost. Depositing money into the machine is slow and requires a larger and more complicated device. Additionally, the power consumption of such devices is very high, and can become quite costly.

### SUMMARY OF THE INVENTION

An object of the present invention is to provide a system for quickly processing orders through a wireless system. Another object of the present invention is to provide rapid method of payment through a wireless personal retail tool.

In one preferred embodiment, a customer uses a personal retail tool or other wireless communication device to connect with a wireless transaction server. In the illustrated embodiment, the personal retail tool is sized and configured for use as a keychain attachment. The wireless transaction server ushers the customer through the transaction process without use of employee time. In another preferred embodiment, a customer uses a wireless device to connect to the wireless transaction server solely in order to pay for an already prepared transaction. Preferably the personal retail tool can be used at several different retail locations.

### BRIEF DESCRIPTION OF THE DRAWINGS

FIG. 1 illustrates a personal retail tool employed as a keychain device.

FIG. 2 illustrates a consumer employing the personal retail tool of FIG. 1 to wirelessly communicate with a receiver at a retailer base station (shown attached to a cash register).

FIG. 3 illustrates six buttons forming the key pad of the preferred personal retail tool of FIG. 1, which buttons perform all of the functions described herein.

FIG. 4 illustrates functions associated with the buttons in three different use modes.

FIG. 5 schematically illustrates software processes associated with the retail transaction server, including possible options for connections to the retailer's back-end server and to the customer.

FIGS. 6-13 illustrate an exemplary purchasing transaction, showing at least part of messages displayed to the user during the process.

### DETAILED DESCRIPTION OF THE PREFERRED EMBODIMENT

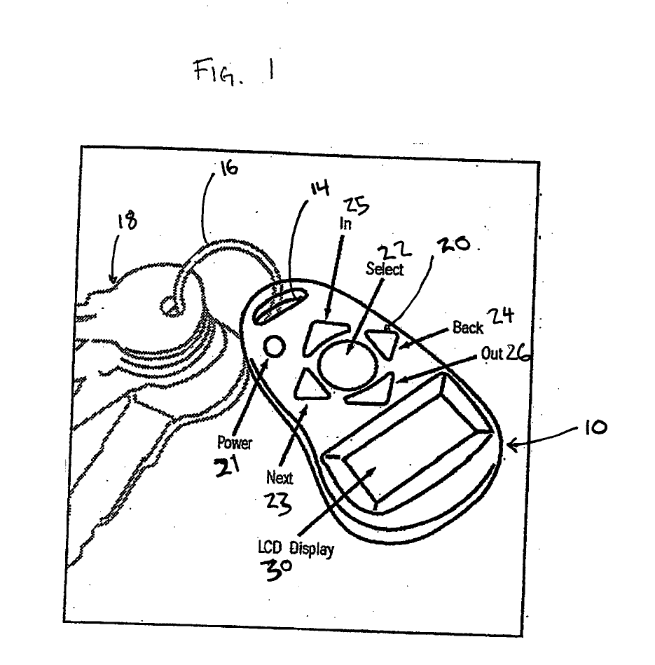

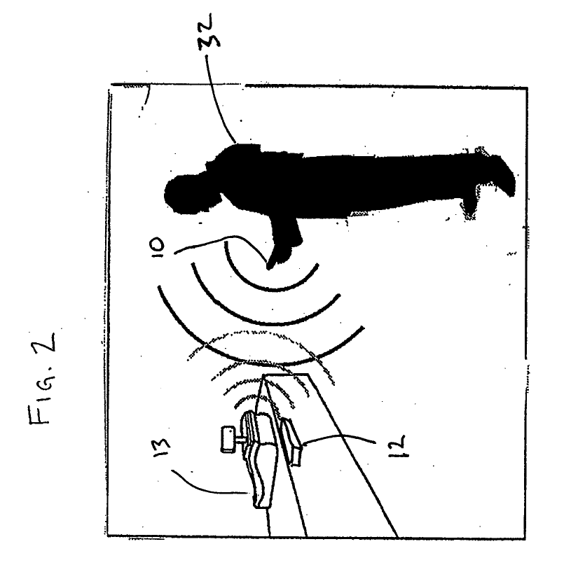

With reference to FIGS. 1 and 2, illustrated embodiment of the retail transaction system described herein takes the form of a keychain personal retail tool device 10 and small retail transaction server 12. FIG. 1 shows the personal retail tool device 10 with an opening 14, a key ring 16 extending through the opening 14, and keys 18 on the key ring 16 for size comparison. By keeping the keychain device 10 small with the limited functionality, the device is cheap, small and highly portable. The small size of the receiver along with its lack of input or output devices keeps it cost-effective. Since consumers generally will carry a keychain along with them wherever they go, the personal retail tool 10 presents no added burden. Furthermore, manufacturing costs are low for such a simple device, making investment on the part of the retailer or consumer minimal, thus making it more likely to find widespread use sufficient to implement the systems at multiple retailers and gain market acceptance.

Preferably, the personal retail tool 10, also referred to herein as a keychain device, weighs less than about 60 grams (<about 2 ounces) and more preferably less than about 40 grams (<about 1.5 ounces). Preferably the device 10 includes a small input device. In the illustrated embodiment, the input device comprises a keypad 20 with less than 10 buttons total, more preferably less than 8 buttons.

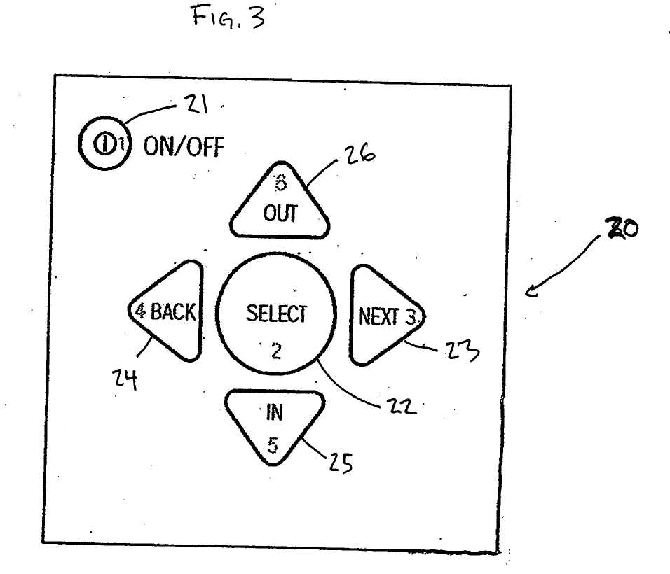

In the embodiment of FIGS. 1, 3 and 4, the personal retail tool or device 10 can perform all of the functions described herein with only 6 buttons. The six illustrated buttons each have two labels in the illustrated embodiment. The default mode label is on each button while the PIN mode digit label is in a different color. The illustrated buttons include an ON/OFF button 21 (also labeled with the number “1”), a central SELECT button 22 (also labeled “2”), a “NEXT” button 23 (also labeled “3”), a BACK button 24 (also labeled “4”), and IN button 25 (also labeled “5”) and an OUT button 26 (also labeled “6”).

FIG. 4 illustrates in a table format the ability of the illustrated six buttons to accomplish 18 functions by selecting among three different modes of use: PIN Mode, Default Mode, and Select Mode. The modes can be selected by user operation of the key pad 20 itself or by signals received from the retail transaction server 12. For example, the device 10 can enter the Select Mode if the SELECT button 22 is held down. The SELECT button 22 can thus act much like a shift key on a standard keyboard. The personal retail tool 10 can enter the PIN Mode to allow a user to enter a personal identification number (PIN) either by pressing down and holding the SELECT button 22 again or by receiving a request for PIN Mode from the retail server 12. In the PIN Mode, the POWER button 21 and the SELECT button 22 are assigned PIN digit values.

If the personal retail tool 10 is off, then pressing the POWER button 21 for less than a second turns the device 10 on without a backlight. If the POWER button 21 is held for more than one second, the tool 10 powers up with the backlight on. On the other hand, if the personal retail tool is on and in the PIN Mode, then pressing the POWER button 21 inputs the button's digit value (“1” in the illustrated embodiment).

Another feature that lends itself to minimizing the size of the personal retail tool 10 is the small size of a display screen 30 that allows the user 32 (FIG. 2) to respond to options presented and scroll through menus. Preferably the screen 30 is designed to display no more than 20 characters at once, more preferably no more than 15 characters. Exemplary screens display only between 5 and 15 characters, and in the illustrated embodiment displays only 8-10 characters. The screen 30 is preferably less than 250 pixels by 50 pixels, more preferably less than 150 pixels by 35 pixels, and in the illustrated embodiment is only 122 pixels by 32 pixels. In terms of absolute size, the screen 30 preferably is less than about 100 mm by 25 mm (2,500 mm²), more preferably less than 75 mm by 20 mm (1,500 mm²), and in the illustrated embodiment is only 60 mm by 16 mm (960 mm²). Words longer than the capacity of the screen to display at once can be scrolled across the screen in a ticker style at a speed that is readily discerned by the average user (e.g., about 6 characters per second).

Within the personal retail tool 10 is a low-power transceiver, an eight-bit microcontroller and some amount of nonvolatile memory. The personal retail tool 10 is preferably designed so that a coin battery can last six months to a year before it needs to be changed. This long battery life is possible because, like the remote control for a car, the tool 10 is powered off most of the time and because the components inside are designed to use very little power in use. Power is preserved by employing a liquid crystal display (LCD) with an optional back light option that can be selectively used for reading under low light conditions. Power is also preserved, and cross talk among multiple devices avoided, by employing a relatively low range communication system. Preferably the range of the device is less than about 20 m, more preferably less than 15 m, and in the illustrated embodiment the device has a range between about 5 m and 15 m. Preferably the personal retail tool 10 consumes between about 1 μW and 500 μW and more preferably between about 50 μW and 300 μW during operation.

The information stored in the nonvolatile memory of the tool 10 is organized in a database of cookies. The highly personalized nature of the experience users have with their personal retail tool 10 is made possible because of user preferences and other information contained in these cookie values. The properties of a cookie include the unique ID of the cookies' remote owner, the cookies protection level and the cookie value. The cookie values are typically encrypted and thus stored in the personal retail tool's nonvolatile memory simply as a series of bytes.

As discussed in more detail below, the system described herein is secure and therefore more likely to garner widespread acceptance. A cookie's protection level defines who can access the cookie. Most cookies are “private.” Private cookies are accessible only to the cookie's owner. Private cookies are typically encrypted by the owner using an encryption key that is never sent to the personal retail tool 10. This is done in order to prevent a hacker from modifying the value of a private cookie. The value of “protected” cookies, on the other hand, can be accessed by everyone but modified only by the cookie's owner. Examples of cookies having this protection level include a user's name, contact information, or picture. Software within the personal retail tool enforces limitations on access to protected cookies. Furthermore, protected cookies can be encrypted using a personal identification number (PIN). But an industrious hacker with physical access to a personal retail tool 10 could change the value of unencrypted protected cookie and so these cookies are less trustworthy than are private or encrypted cookies. The value of public cookies can be seen and even modified by anyone. One possible use of public cookies would be to store video game high scores.

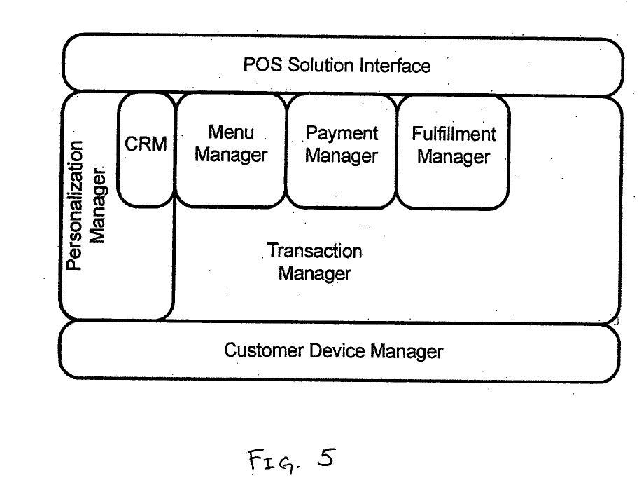

In operation, as will be better understood from the example discussed below with respect to FIGS. 6-13, when the personal retail tool 10 is powered up, it scans the airwaves looking for a responsive retail transaction server 12 with which to communicate. The results of this scan are presented to the user as a menu of welcome messages. At the end of this menu is an entry entitled “PREFS.” The user 32 can choose this item to manage their personal retail tool 10 preferences. The personal retail tool 10 can be used to store payment information such as debit/credit accounts and cash payload balances. Most nonvolatile account information is stored in an encrypted form that can be decrypted into random access memory (RAM) by using the user's PIN as the decryption key. Note that a PIN is never stored in nonvolatile memory.

The following properties of an account can be managed via the account preferences menu once the user has entered his or her PIN:
Balance: this is a read-only property showing the balance of a payload type of account;
Daily Limit: representing the maximum amount payable from this account per day;
Spent Today: representing the amount paid from this account so far today;
Protected: indicates whether the user must enter their PIN in order to use the account; and
Friends: a set of cookies for which this account is authorized.

The cookies preference menu can be used to manage the set of cookies stored on the personal retail tool 10. While cookie values are encrypted and not available for viewing by the user, this menu can be used to delete a cookie and to view/change its associated default account.

The PIN preferences menu is used to change the PIN for the personal retail tool 10. As is standard practice when changing a password, the user must enter the current PIN before being allowed to change it. The process of changing the PIN requires that the user enter the new PIN twice for confirmation. This preferences menu is also used to modify the duration that the personal retail tool 10 can remain unlocked when the PIN is entered. This duration can be for the length of a single transaction, a variable period of time (e.g., in increments of an hour for up to 24 hours) or permanently (thus disabling PIN protection). The default unlocked duration is a single transaction, such that the user will need to re-enter his or her PIN after every transaction.

The time-out preference menu allows the user to set an activity time after which the personal retail tool 10 automatically powers down to save energy. The possible values are 30 seconds, one minute, two minutes, and three minutes in a preferred arrangement.

Confidential information stored in nonvolatile memory on the personal retail tool 10 is preferably encrypted using the PIN. But in order to ensure that a lost or stolen tool cannot be hacked, the PIN itself is never stored in nonvolatile memory. Therefore, there is no way to recover a forgotten PIN, thus rendering sensitive information on the personal retail tool 10 permanently inaccessible. The reset preference menu allows the user to reinitialize nonvolatile memory. While this will result in the loss of account information and cookie values, it will also allow the user to start using the personal retail tool 10 again with fresh data.

The server 12 is an appliance about the size of a small pizza box that is installed in a retail outlet's customer area, shown in FIG. 2 beneath a cash register 13. The server 12 itself connects to the retailer's intranet much like a cash register. Beyond a power cord and a network connection (e.g., an RJ45 network connector), the server 12 includes, in an exemplary arrangement, five USB 2.0 ports, a set of LED status indicators and a reset button. No keyboard or display are necessary as administration can be via a remote browser interface. The device stays operational as long as it has power. Because there is no need for regular physical access to the server 12, the server 12 can be installed out of sight where it does not interfere with other operations, as illustrated in FIG. 2.

The retail transaction server 12 is not limited to use with the keychain device 10. The server 12 preferably communicates directly with wireless devices, such as the illustrated personal retail tool 10 and any other wireless devices that support Bluetooth™, infrared, and/or WI-FI™. The server preferably can communicate with cell phones and other devices that rely on telecommunications infrastructure via a secure TCP/IP tunnel.

The server 12 is designed to appear as a cash register to a retailer's back-end server. However, instead of a cashier standing in front of a cash register and taking orders and processing payment by pressing buttons, the server 12 enables customers to place orders and make payment on their own, without first waiting in line, without rushing and without interacting with a cashier. Alternatively, customers who would rather place their order with a cashier can still use the retail server 12 solely to pay for their purchases. In either case, a retailer's transaction velocity increases significantly and customers appreciate the option of not having to stand in long lines and the convenience of not having to carry cash or other payment means.

The server's cross-platform design allows for integration into most target retailer's point-of-sale (POS) solutions, even in custom environments. The server 12 can preferably converse with multiple mobile devices at once regardless of the wireless communication channel. It appears to the customers as if they have a full service cash register dedicated to them as they place their order.

There are four steps in the purchasing interaction between the server 12 and the mobile device such as the personal retail tool 10, as discussed in more detail below with respect to FIGS. 6-13: Welcome, Ordering, Payment and Thank You. The server 12 communicates with the mobile device at the beginning of each step to configure the mobile device for that step. The data collected through user interaction with the device 10 during each step is transmitted back to the retail transaction server 12 at the end of the step. After processing this resultant data, the retail transaction server 12 will configure the personal retail tool 10 to advance to the next step or alert the user 30 to an error condition and repeat the prior step.

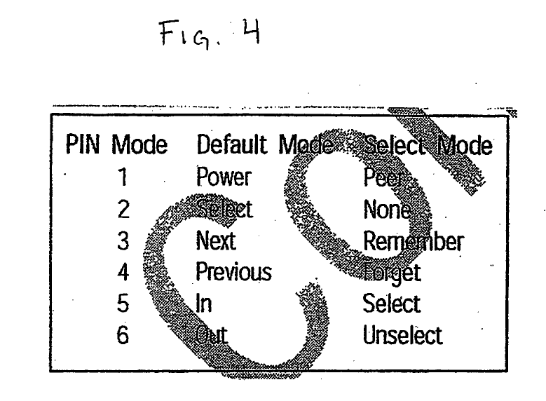

FIG. 5 illustrates software modules of the system formed by the personal retail tool device 10 and the retail transaction server 12. Mobile devices such as the personal retail tool 10 interact with the user 32 autonomously during each step, while the decision to advance to the next step or alert and repeat the current one is made by the server's Transaction Manager software. The Transaction Manager also oversees the purchase as it progresses and interfaces with the other server 12 software modules.

As the server 12 connects to the back-end server at the retailer location, and regular intervals thereafter, the server 12 downloads the store's SKU list, which is a list of items sold, the price of each item, and the list of options associated with each item. This information is used by the server Menu Manager software module to generate the full menu of items the user can choose from when placing his or her order.

A self-service buying experience is preferably friendly and personal. People should feel comfortable about the interaction they have during their purchase. The server 12 has a Personalization Manager software module that uses identifying information, such as a mobile device's unique identification or ID number, a phone number and/or a retailer-specific cookie value, to generate a highly-personalized customer experience. The Personalization Manager is in this way responsible for managing the Favorite's Menu and, in conjunction with the Customer Relationship Manager software module (abbreviated “CRM” in FIG. 5), any suggestions, coupons, or discounts presented to the customer.

The Payment Manager is the component of the retail transaction server 12 that processes payments. This software module can handle credit/debit accounts as well as storing value cards, fare cards, and in conjunction with an Affinity Manager that may be a subcomponent of the Customer Relationship Management software module, any retailer-specific affinity accounts.

Once completed, an order is scheduled for fulfillment by a Fulfillment Manager software module. If an order has been made for pick-up or delivery at a later time, the Fulfillment Manager will schedule the submission of the completed order to ensure that it will be ready and fresh when it is due.

The retail transaction server 12 preferably also includes a lightweight web server so that it can be configured and status queried by referring a web browser. The server 12 can also be centrally administered using standards-based network management applications.

With continued reference to FIG. 5, the retail transaction server also includes point-of-sale (POS) solution interface and customer device manager software modules.

The POS Solution Interface is preferably configured to communicate with any of several types of application software that runs on cash registers and on the back office servers to which the cash registers are connected via a network interface. Such pre-existing retailer software is called POS solution software. There are several POS solution vendors that develop and market solution software. Three exemplary vendors are Aloha, PixelPoint and Maitre'D. Because the interfaces to POS solution software from each vendor are different from the software provided by the others, the POS Solution Interface software module of the retail transaction server 12 provides a consistent programming interface so that other parts of the retail transaction server software can communicate with the POS solution software without regard to the which vendor's software is used by the retailer.

The retail transaction server software has been designed to allow consumers to submit self-service transactions using the keychain-based device this patent refers to. But the server 12 is also designed to accept transactions that originate from other types of devices as well—such as mobile phones, PDAs, laptops, kiosks, voice recognition servers, etc. The Customer Device Manager software module of the transaction server 12 provides a consistent programming interface so that other parts of the retail transaction server software can process transactions that originate on any type of supported devices.

In general, together, the retail transaction server 12 and the keychain device 10 form a system with which the consumer 32 can relay preferences to a retailer's computer system, allowing an order to be entered into a queue as soon as the user makes the order, without having to wait for retail personnel availability for taking the order. This is particularly useful for the consumer that has habitual repeat orders of the same type, but also enables real time selection based upon menu choices made available by the retailers computer system. In fact, with appropriate display rack modifications or other security hardware, the system enables full self-service operation, alleviating the need for retail personnel.

Furthermore, the system enables rapid and convenient payment transactions, again without involving personnel at the retailer end. The users can simply authorize payment by conventional means, e.g., charging a credit account or bank debit account, without having to provide the actual bank or credit cards. The secure system and use of a personal identification number (PIN) in order to use the device 10 is enough security for the retailer to accept payment without separate security measures (e.g., checking ID). The keychain device 10 also enables a unique payment scheme whereby a retail store-specific or chain-specific account, such as a department store credit account or a coffee house stored value account, is accessed by the device 10. Unlike conventional stored value cards, such as frequently employed by retail clothing and coffee house chains, the value of the account need not be kept on a card (which can be stolen and used) but instead can be stored on the retail server or on the personal retail tool itself, which can provide added security by optionally requiring that a PIN be entered before an account is used for payment. Unlike existing RF-ID devices, however, the device has flexibility for use with multiple different retailers, and furthermore enables the user to view his or her balance and check on charges on the device's own display screen 20 prior to authorizing payment.

FIGS. 2 and 6-13 illustrate an exemplary purchasing transaction employing both the personal retail tool 10 and the retail transaction server 12 of the preferred embodiments. As noted above, there are four basic stages to the interaction between the personal retail tool 10 and the retail transaction server 12: Welcome, Ordering, Payment, and Thank You.

At the Welcome stage of the interaction, the dialog between the personal retail tool 10 and the retail transaction server 12 begins when the user 32 activates the personal retail tool 10. As it powers up, the personal retail tool 10 scans the frequencies assigned to it, looking for a retail server 12 that is within the range of the personal retail tool 10. If more than one retail transaction server 12 is found, as might be the case in a mall, the user can stroll through the welcome messages from each retailer until the proper one is selected. See FIG. 2.

After the welcome message is dismissed, the personal retail tool 10 searches its nonvolatile memory for encrypted preferences information owned by the selected retailer. The results of this search, along with the unique ID of the personal retail tool 10, are sent to the retail transaction server 12.

With reference to FIGS. 6 and 7, the start of the Order stage is a good time for the retailer to make product suggestions or offer discounts on selected items. These are presented to the user in the form of alerts that they dismiss before proceeding with ordering their process. FIGS. 6 and 7 illustrate portions of such offerings to the user 32, which may additionally include prices and conditions which can be accessed by scrolling using the keypad 20. Using preference information extracted from the personal retail tool 10, or using default information if this is the user's first visit, the Personalization Manager (FIG. 5) of the retail transaction server 12 constructs a personalized “Favorites” menu of items the user has bought before or manually committed to memory during previous visits. This Favorites menu, along with the retailer's full menu, is transmitted to the personal retail tool 10.

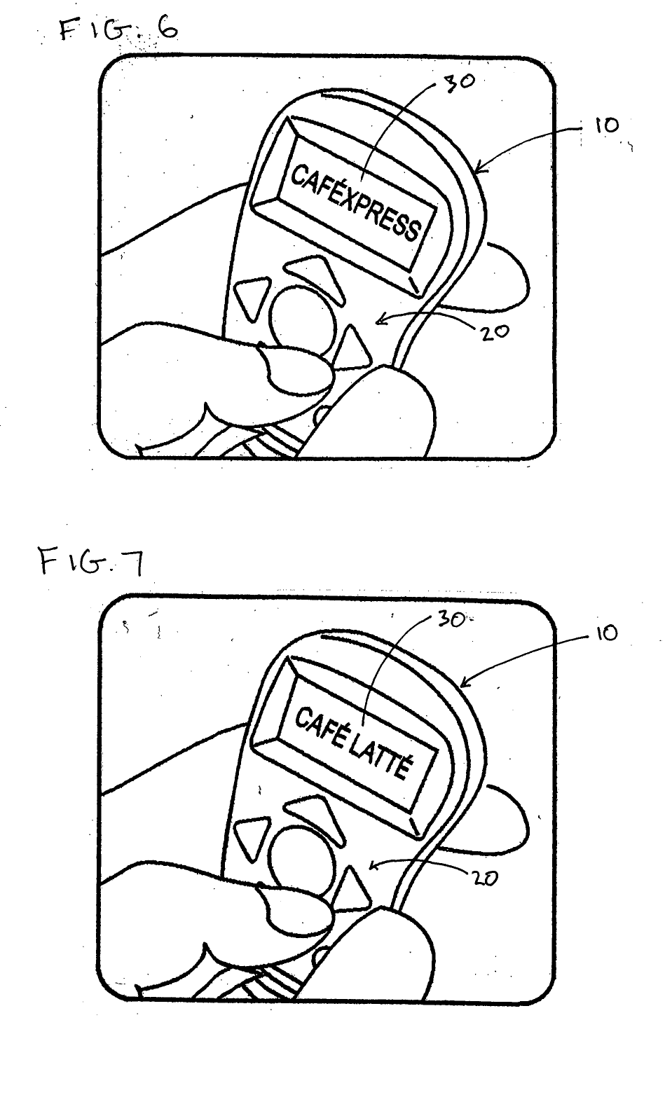

With reference to FIG. 7, if an item displayed for order is desired, the user 32 presses the SELECT and IN button combination. This button combination is pressed repeatedly to increase the quantity to be ordered. Similarly, to decrease the SELECT and OUT button combination can be used. The item is removed completely from the order once the quantity of the item goes to zero. The quantity ordered is shown to the left of the item name as shown in FIG. 8.

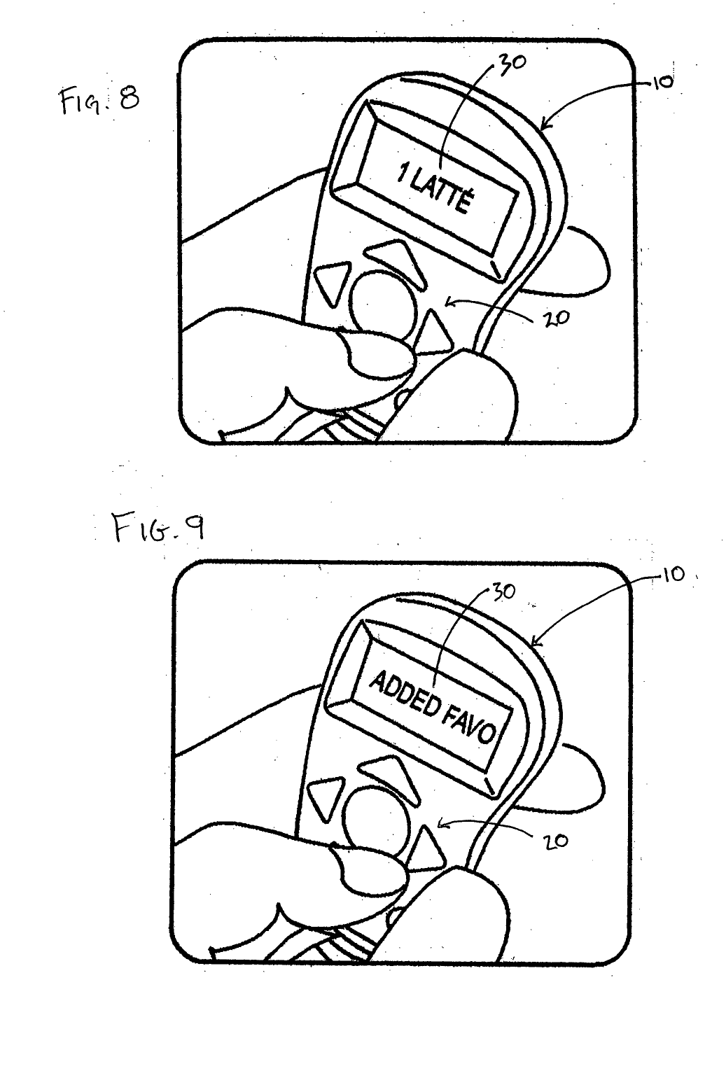

As a default, items that are actually ordered off of the retailer's full menu can be automatically added to the user's Favorites menu. To add an item to the Favorite's menu for this retailer without ordering it, the user can press the SELECT and NEXT combination of buttons. As in ordering, a user increases the remembered quantity of an item by repeating the SELECT and NEXT combination and decreases this quantity by pressing the SELECT and PREVIOUS buttons. FIG. 9 illustrates a message displayed to the user after adding a favorite to the Favorites menu.

Once the user 32 has made his selections, the order is transmitted to the retail transaction server 12 so that the order can be inputted and tallied by the Transaction Manager software module of the retail server 12. The completed order, with taxes, shipping and other applicable surcharges added, is then sent back to the personal retail tool 10 with the total displayed on the display screen 30. FIG. 10 illustrates such a total amount displayed on the screen 30.

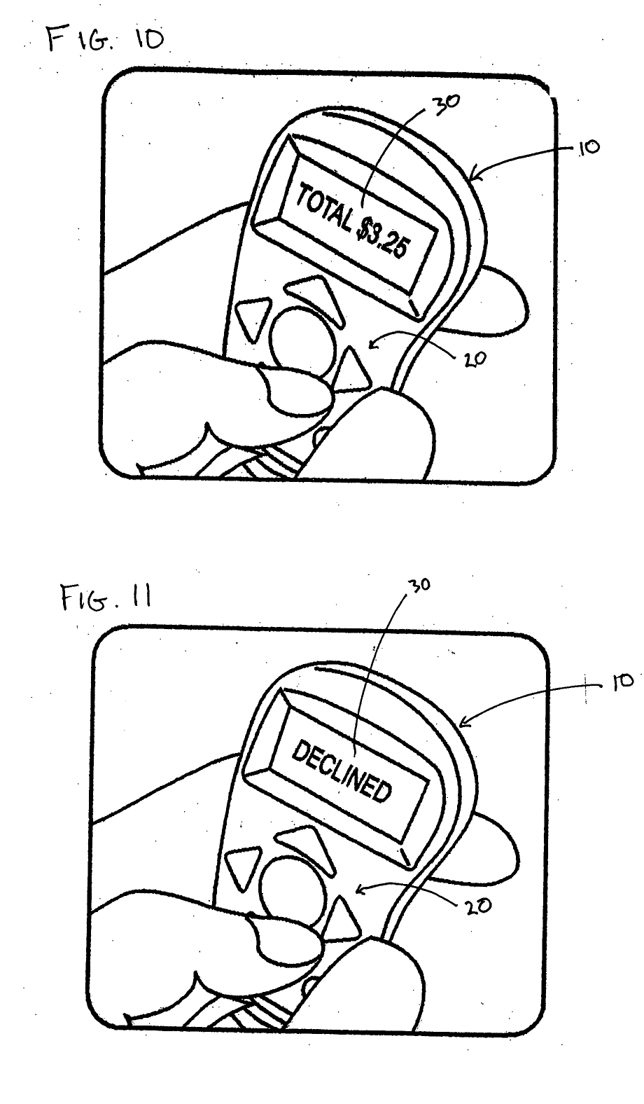

While the user can at this point inspect the details of the order and changes can still be made, a single SELECT/IN button press is all that is needed to pay the order using the default account associated with the retailer's cookie. Payment is made using encrypted account information stored on the personal retail tool 10. Debit and credit cards are supported, as are cash payload values. While a default account is associated with each retailer, the user can override this default for a particular order. If an account is declined (see FIG. 11), an informative alert is displayed to the user 32. Dismissing this alert by pressing any scroll button returns the user 32 to the order total. From this point, the user 32 can modify his order or select an alternative payment account.

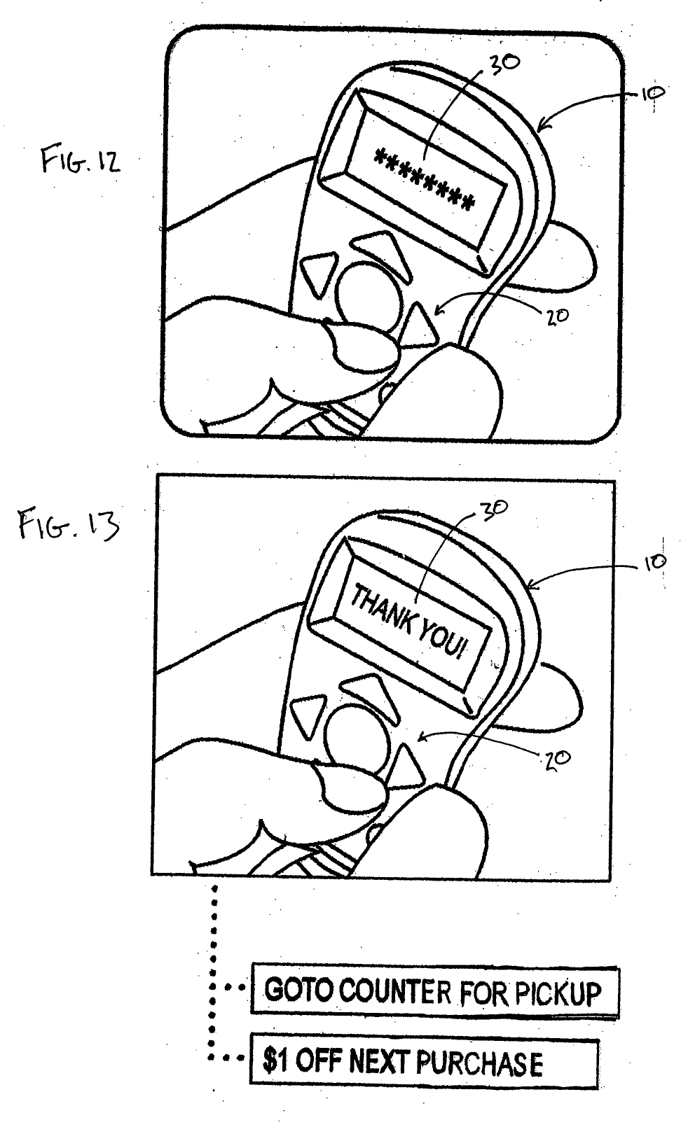

As described above, the account information and preference values can be stored on the personal retail tool 10 in encrypted form. Thus, together with the controlled access that the API of the tool 10 software provides to this data, encrypted data is secured should a hacker gain physical access to the personal retail tool 10. Sensitive information is encrypted using the user's PIN as the encryption key. The user must enter the PIN (FIG. 12) in order to access this information. Any step that attempts to access PIN protected data will cause the user to be prompted to enter their PIN.

At the Thank You stage of processing, once payment information has been communicated to the retailer's server 12 and approvals obtained, the user 32 is presented with a message thanking them (FIG. 13) and perhaps telling them how to pick up their order. This may also be an opportunity to present the user with a coupon redeemable on the next visit. The properties of such an offer would be stored in the updated preference information encrypted by the retail transaction server 12 and stored on the personal retail tool 10.

Portability, Compactness and Ubiquity of the Personal Retail Tool

The device 10 designed to be attached to the user's keychain. It is more convenient for users to pick up a keychain than it would be to select individual items. Being on a keychain also increases the chance the user will have the device with them, because a person's keychain and money are the two items they are most likely to carry with them outside their homes. A much higher percentage of people own a keychain than own a cell phone or PDA—, which are two other devices that could perhaps facilitate wireless transactions in the future.

The keychain device 10 smaller than a wallet, cell phone or PDA. This makes it more convenient for user to carry the device around with the user when he shops or even when he is just walking around outside. It is also a strong motivation for users to change their payment method preference toward using the device instead of using cash, a credit card, a debit card, a stored value card or other alternative means of payment.

The device can contain information about several user accounts at one time. By using the device, a user can pay for purchases using any of these accounts. Yet adding information about additional accounts does not increase the size of the device the way adding another card to one's wallet increases the bulk of the wallet. Additional accounts on the device would take up relatively little of the nonvolatile memory on the device, allowing for several accounts on a single keychain device.

A consumer that participates in the various forms of affinity programs, frequent buyer programs or redemption programs of a retailer typically has to carry around a card of some type for each one. These cards come in many forms and serve multiple purposes:
A membership card may simply have the retailer's name printed on it or it may contain a magnetic strip or bar code to allow the retailer to scan the card during a user visit;
Some retailers hand out paper cards to participants of their frequent buyer programs. A punch, a stamp or some other distinguishing mark is added to the card each time the user purchases a qualifying item. The user qualifies for a discounted purchase after accumulating a defined number of marks on the card;
A retailer may offer a volume discount when a user pre-pays for a minimum number of items at once. The user carries around a ticket, coupon or stamp for each of the purchased items, which are used in payment when the user consumes items at a future date;
When a user returns an item they may be given a magnetic strip card or printed paper to indicate a store credit redeemable for a certain value on future purchases.

The device 10 can be used to serve the same purpose as any of the aforementioned manual items. Yet joining any of these programs does not increase the size of the device 10 the way adding another card to one's wallet increases the bulk of the wallet.

The device 10 is capable of managing a user's personalization information for multiple retailers at once. This allows a user to carry a single device that can be used at several different retailers' stores. So the user does not need to carry around multiple devices, one for each retailer, as they might for retailers' private-labeled stored value cards. Furthermore, the user can choose to employ a single PIN to unlock all of these accounts.

The device 10 has fewer buttons than other devices such as cell phones and PDAs. The button count of the device is as low as it is because the function of each button differs depending on the mode or state that the device is in. This reduces the apparent complexity of the device for end users. It also allows the device to be much smaller than would otherwise be possible.

The simplicity of the device 10, as compared to other devices that might be used for wireless transactions such as cell phones and PDAs, allows the device to be manufactured at a lower cost than these other devices. This allows the retailer to distribute the device to a wider set of consumers than would be possible if the device were more expensive. With more devices in distribution, more users are likely to use the device and therefore both retailers and end users will experience the benefits of the device more often.

Wireless Capabilities

The device 10 automatically stores, manages and communicates the user's personal preferences and contact information to the retailer during each visit. This eliminates the need for retailers to provide forms for users to fill out and eliminates the need for users to manually communicate this information during every visit, which would be necessary using paper or verbal ordering mechanisms. This also makes signing up for a new loyalty program, stored value program, or other account simple for the end user of the keychain device.

All wireless communication between the device 10 and the server 12 at the retailer end is encrypted using public key encryption. The encryption protects the user's information being seen by other consumers or even by store personnel. This reduces the chance that contact information, confidential information or account information could be used for identity theft or other unlawful or unwanted purposes.

The device 10 supports a wireless protocol that allows multiple users to carry on a dialogue with the retailer's POS system at the same time. This provides a friendlier user experience than would be the case if other wireless technologies were used, such as the technology used by TV remotes or garage door openers.

The frequency that the device 10 uses for wireless communication is in an unlicensed band. Preferably the communication frequency is between about 2400 MHz and 2483.5 MHz. This reduces the overhead expense of operating the devices, as licenses do not need to be purchased. The device 10 can be used both in the United States and internationally without modification because the frequency band that the device uses for wireless communication is free for the same use in all areas. This is better than the wireless communication bands used by most cell phones and PDAs here in the United States, which are typically in the range of 800 MHz to 2000 MHz.

The effective range of the wireless communication between the device 10 and the retailer's server 12 is a maximum of from 10 to 70 meters. This allows the server to assume with a high degree of certainty that an activated device within range is trying to order from that store. This has benefits over other devices that utilize wireless technologies with greater range, such as cell phones and PDAs, which must use other means to identify the store from which the user wishes to order. These other means include the user manually identifying the store of interest or the use of GPS or other geo-location technologies.

The keychain device 10 is designed for a low duty cycle. That is, the device is by default powered down while it is not in use. The device 10 only consumes power when the user is interacting with the device during the ordering or payment process. The device automatically powers off after a short period of inactivity. This results in much longer battery life than other devices such as cell phones and PDAs that use other wireless protocols, which are typically always on.

When the keychain device 10 is activated it scans the airwaves looking for a network of devices to join. The device is capable of entering a network very quickly, preferably within 30 ms. This provides a faster and more friendly user experience than other devices such as cell phones and PDAs that use other wireless protocols, which typically take a few seconds to enter their network.

The wireless protocol used by the system can communicate using one of several possible frequencies. This will tend to reduce the possibility of network contention, and thus increase the chance of a sale being completed, relative to using other means of wireless communication.

The wireless protocol used by the system (IEEE 802.15.4, which is incorporated herein by reference) allows for very low power operation, in the range of a few hundred micro-watts of transmission power. The device 10 automatically powers off after a short period of inactivity. This results in much longer battery life than other devices, such as cell phones and PDAs, that use a watt or more of transmission power.

The wireless protocol used by the system conforms to an IEEE standard physical and link layer protocol, as well as another standard protocol for the upper layers. This allows the device to be designed and manufactured at a lower cost than potentially competing devices that use proprietary protocols.

The wireless protocol used by the system was designed to be extremely simple as compared to other alternative protocols. This greatly reduces the complexity and cost of the components used in the construction of the device 10.

The cost of the wireless server 12 is also greatly reduced because of the standard protocols in use. These low costs increase the set of retailers who can afford to install equipment attached to their POS system for allowing end users to order and pay for purchases using the device.

The transceiver of the keychain device 10 is powered off except when the user is interacting with a retailer. This contrasts with cell phones, WI-FL, BlueTooth™ and other wireless services that are periodically “pinging” the network to confirm that they are still active and within range. The powered off nature of the device better protects the user's privacy, as it is not possible for the network to know where somebody with a device is unless the user is actively interacting with a retailer.

Security

Retailer-specific personalization information is stored on the device 10 in encrypted form. The key used to encrypt and decrypt this key is known only to the retailer and is never stored in volatile or nonvolatile memory on the device 10. This ensures that the encrypted information is protected from attempts to hack the device, even when the hacker has physical possession of the device 10 and tools for gate-level physical access to the information on the device.

Whether other non-retailer-specific information is stored in nonvolatile memory in encrypted form on the keychain device 10 is based on user preference. The preference management portion of the user interface allows the user to define the level of security used for each payment account and other non-retailer-specific personal information. Any of this information that is stored in encrypted form uses a Personal Identification Number (PIN) as the encryption key. This PIN never stored in nonvolatile memory on the device. This also helps to ensure that the encrypted information is protected from attempts to hack the device, even when the hacker has physical possession of the device 10 and tools for gate-level physical access to the information on the device.

The user can assign a spending limit on each account. These limits include the maximum amount spent during any given day. Any attempt to use the account beyond his or her assigned limits will be declined (though the user may be allowed to select a different account to pay for an order.) The process of configuring account information and spending limits requires that the user enter his or her PIN. This level of control provided by the device 10 acts an additional security feature that limits the ability of other users, miscreants or thieves from using the device outside the bounds of these controls.

The user must enter his or her PIN in order to access information that is protected using the PIN as the encryption key. The duration in which the PIN key is in volatile memory for use in decryption can be changed according to user preference. Possible preference settings are, e.g., to keep the PIN for the duration of a single transaction, to keep it for a preset period of time, or to permanently keep it (or at least until the device is reset). This level of personalization of security preferences has advantages over either no PIN security or rigid security in that it is able to better match the user's interests.

The user can control the number and identities of retailers for which an account can be used for payment. In contrast, the user cannot configure other payment methods, such as credit cards and debit cards, to limit which retailers at which those cards can be used. There are several advantages to the level of control the device provides. Firstly, it enforces a predetermined usage policy without further intervention by the user once they have configured the account. Secondly, this level of control provided by the device 10 acts an additional security feature that limits the ability of other users, miscreants or thieves from using the device outside bounds of these controls.

Retailer Benefits

Retailers can choose to support payments by consumers using the device 10 as well as any other payment methods. This provides retailers with more flexibility in their choice of accepted payment methods relative to some merchant service agreements, which require retailers to accept all offered payment types (credit and debit cards, for example).

The device 10 allows retailers to increase the maximum number of sales they can handle in a given interval without adding additional counter space, cash registers or personnel. The retailer's box can be placed underneath the old-style cash register 13 or under a counter to avoid any unnecessary waste of space.

The front of the keychain device 10 can be imprinted with a retailer's logo, brand or message. This results in increased awareness of the retailer by the end user of the device. Because people carry around their keys much more often than they do a cell phone or PDA, the level of increased exposure is higher than would result from imprinting these other devices. Further, people's keys are out more often and for longer periods of time than credit cards, debit cards, stored value cards or other payment methods.

Customers are likely to appreciate the fact that they can enjoy the benefits of the device 10 in the stores of multiple retailers, not just in the store of the retailer whose name is imprinted on the device.

Because personalization information about the user is stored on the device 10 and communicated to the retailer during a transaction, along with the fact that this personalization information can be updated at the end of every transaction, the retailer can provide consumers with a very tailored user experience without the need for each outlet being directly connected to the store's central server. Nor does every store need to have prior stored knowledge of a user's personal information kept on each cash register or store-resident POS server. This allows the device 10 to be used to maximum benefit with a minimum investment in IT infrastructure, as compared the same level of personalization that might be possible using other payment methods.

It is highly unlikely that any single cell phone carrier or WI-FL carrier share the same set of customers as the set of all customers that patronize a retailer. In fact, it is likely that the penetration of any single carrier is not more than about 30% in most major markets. So, while it is likely that the cost of a cell phone is not likely to fall to the point where they can be given away for some time, the low cost of the retail device allows retailers to distribute the device for free or almost for free to a very high percentage of customers. This allows retailers to reach a larger percentage of their customers than any single wireless carrier can deliver and therefore more easily justify the retailers' investment in the equipment and devices.

Wireless Server Benefits

With reference to FIG. 2 again, the wireless server 12 device is small enough to avoid wasting any retail space, yet is able to accomplish its function. Preferably fitting within a volume of two feet long, two feed wide and six inches high, the server 12 is about the size of a small pizza box and is installed in the retail outlet's customer area. The device has no keyboard, mouse, or display. It is completely administered by a remote browser interface. This allows the unit to be installed out of sight where it does not interfere with other operations. The server's cross-platform design allows for integration into most retailer's POS solutions.

The wireless server 12 communicates directly with wireless devices, not just the keychain device. While the personal retail tool 10 described above is designed for and is easily used with the wireless server 12, other devices can access the wireless server 12. It can communicate by infrared, WI-FI, BlueTooth™, and telephone infrastructure using a secure TCP/IP connection. The server 12 can also converse with multiple devices at once regardless of the wireless communication channel. For example, the server 12 can communicate with a retailer's intranet, wirelessly or via hardwire, and indirectly or directly with the retailer's back-end servers housing user's stored value accounts and/or the retailer's inventory databases.

The wireless server 12 is designed to appear as a cash register to a retailer's back end server. However, instead of a cashier operating the register, the server 12 allows customers to place orders and make payment on their own without waiting in line. Additionally, the customer 32 can use the system to order, and pay the cashier. Or, the customer 32 can simply use the server 12 to pay after ordering from the cashier. In any of these methods, the retailer's transaction velocity increases and customers remain satisfied with either the ordering experience, if the customer chooses to pay with cash.

There are four steps in the transaction between the server and the mobile device; Welcome, Ordering, Payment and Thank You. The server communicates with a mobile device (e.g. the personal retail tool, a programmed PDA, or a wireless phone) at the beginning of each step to configure the mobile device for that step. The data collected through user 32 interaction with the device 10 during each step is transmitted back to the server 12 at the end of the step. After processing the data, the server 12 will configure the device 10 to advance to the next step or alert the user to an error condition and repeat the prior step.

The server is enhanced by software built specifically for the tasks required. The server will have modules to move the customer through the transaction, to personalize the customer's experience, to handle the payment process, to fulfill the order, and to administer the server.

It will be appreciated by those skilled in the art that various omissions, additions, and modifications can be made to the processes and structures described above without departing from the scope of the invention. For example, and without limitation, all references to personal identification numbers (PIN) can be replaced with bioinformatic tools if costs and size can be adequately reduced by future technologies. For example, thumbprint scanners can be employed to replace entry of a PIN. All such modifications and changes are intended to fall within the scope of the invention, as defined by the appended claims.

1. A personal retail tool, comprising:
a housing;
electronics including a processor and non-volatile memory within the housing, the non-volatile memory storing software configured to display menu choices suitable for user selection of payment and/or consumer preference information;
a data input device configured for user;
a display screen; and
a wireless transmitter having a communication range of no more than about 20 meters.

2. The personal retail tool of claim 1, wherein the housing is sized to serve as a keychain attachment.

3. The personal retail tool of claim 2, having a total mass of less than 60 grams.

4. The person retail tool of claim 1, wherein the wireless transmitter operates a frequency between about 2400 MHz and 2483.5 MHz.

5. The personal retail tool of claim 1, further comprising a wireless receiver.

6. The personal retail tool of claim 1, wherein the wireless transmitter has a communication range of no more than about 15 meters.

7. The person retail tool of claim 6, wherein the wireless transmitter employs a power between about 50 μW and 300 μW.

8. The personal retail tool of claim 1, wherein the data input device comprises a keypad.

9. The personal retail tool of claim 8, wherein the keypad comprises no more than 10 buttons.

10. The personal retail tool of claim 8, wherein the software allows shifting the functions of the buttons to at least 3 different modes, wherein a plurality of the buttons have different functions in each mode.

11. The personal retail tool of claim 1, wherein the display screen is a liquid crystal display (LCD).

12. The personal retail tool of claim 1, wherein the display screen has a size of no more than about 2,500 mm².

13. The personal retail tool of claim 1, wherein the display screen has a size of no more than about 250×50 pixels.

14. The personal retail tool of claim 1, wherein the display screen and the software are configured to display no more than 15 characters at a time.

15. The personal retail tool of claim 1, wherein the display screen and the software are configured to display 8-10 characters at a time.

16. The personal retail tool of claim 1, wherein the software is configured to enable use of the tool upon entry of a correct personal identification number.

17. The personal retail tool of claim 16, wherein the software is configured to communicate different information with a plurality of different retailers.

18. The personal retail tool of claim 17, wherein the software is configured to create accounts with new retailers upon wireless communication with the retailer.

19. A system for communicating with a retail base station with a personal retail tool, the system comprising:
a base station at a retail store location, the base station being connected to a local back-end server; and
a personal retail tool capable of wireless communication with the base station, the personal retail tool comprising an input device, a processor, non-volatile memory and a display screen;
wherein the system is configured to allow user selection of preference selection and/or payment through interaction with the input device and display screen.

20. The system of claim 19, wherein the display screen is configured to display no more than 15 characters at a time.

21. The system of claim 19, wherein the input device comprises a keypad having no more than 10 buttons.

22. The system of claim 19, wherein the wireless communication between the base station and the personal retail tool has a communication range of no more than about 20 meters.

23. The system of claim 19, wherein the personal retail tool is sized to serve as a keychain attachment.

24. The system of claim 19, wherein the personal retail tool has a total mass of less than 60 grams.

25. The system of claim 19, wherein the personal retail tool operates at a frequency between about 2400 MHz and 2483.5 MHz.

26. The system of claim 19, wherein the personal retail tool has a wireless communication range of no more than about 15 meters.

27. The system of claim 26, wherein the personal retail tool employs a power between about 50 μW and 500 μW.

28. The system of claim 19, wherein the personal retail tool comprises an opening configured to receive a key ring therethrough.

29. The system of claim 28, wherein the personal retail tool allows shifting the functions of the buttons to at least 3 different modes, wherein a plurality of the buttons have different functions in each mode.

30. The system of claim 19, wherein the display screen is a liquid crystal display (LCD).

31. The system of claim 19, wherein the display screen has a size of no more than about 2,500 mm².

32. The system of claim 19, wherein the display screen has a size of no more than about 250×50 pixels.

33. The system of claim 19, wherein the personal retail tool is configured to store customer preferences for a plurality of retailers.

34. The system of claim 19, wherein the personal retail tool stores information regarding a purchase in order to present at a future visit to a retailer.

35. The system of claim 19, wherein the personal retail tool is configured to enable use of the tool upon entry of a correct personal identification number.

36. The system of claim 35, wherein the personal retail tool is configured to communicate different information with a plurality of different retailers.

37. The system of claim 19, wherein the personal retail tool can access a stored value account maintained at a retail server.

38. The system of claim 19, wherein the personal retail tool maintains a secured stored value account within its non-volatile memory.

39. A method for facilitating retail transactions at a point-of-sale, the method comprising:
powering on a personal retail tool that has a display screen and input buttons;
wirelessly connecting the personal retail tool to a retail transaction server from a distance of no greater than 20 meters;
taking an order from a customer via the personal retail tool; and
confirming the customer's order and payment information.

40. The method of claim 39, wherein the personal retail tool downloads a menu from the retail transaction server.

41. The method of claim 39, wherein the personal retail tool accesses a stored menu from the non-volatile memory.

42. The method of claim 39, wherein customer is greeted upon connection to the retail transaction server.

43. The method of claim 39, wherein the personal retail tool automatically powers off after the transaction is completed.

44. The method of claim 39, wherein the personal retail tool has a display screen configured to display no more than 15 characters.

45. The method of claim 39, wherein the personal retail tool has less than 8 buttons.

46. The method of claim 39, further comprising offering the customer a special offer after completion of the transaction.

47. The method of claim 39, wherein the personal retail tool transfers payment information to the retail transaction server.

48. The method of claim 47, wherein the payment is transferred from a stored value account located on a back-end server.

49. The method of claim 47, wherein the payment is made from stored value information stored on the personal retail tool.

50. The method of claim 47, wherein the payment is made from a credit account.

51. The method of claim 47, wherein the payment is made from a checking account.

52. A retail transaction server, comprising
a housing;
a wireless receiver; and
electronics including a processor and memory within the housing, the memory containing software that ushers a customer through a transaction process.

53. The server of claim 52, wherein the server arranges delivery of an order in response to a wirelessly signaled order from a personal retail device.

54. The server of claim 52, wherein the housing is less than two feet wide, two feet long, and six inches high.

55. The server of claim 52, wherein the wireless receiver can communicate with multiple protocols.

56. The server of claim 52, wherein the server has no attached display screen nor input peripherals.

57. The server of claim 52, wherein the server is remotely administered via a browser interface.

58. The server of claim 52, wherein the server provides suggestions and discounts to the customer.

59. The server of claim 52, wherein the server connects to a retailer's intranet.

60. The server of claim 59, wherein the server connects to a retailer's intranet wirelessly.

61. The server of claim 59, wherein the server connects to a retailer's inventory database.
